(19) United States
(12) Patent Application Publication
(10) Pub. No.: US 2019/0220563 A1
(43) Pub. Date: Jul. 18, 2019

(54) METHOD OF MODELING ACOUSTIC PROPERTIES

(71) Applicant: Purdue Research Foundation, West Lafayette, IN (US)

(72) Inventors: Prateek Gupta, West Lafayett, IN (US); Danish I. Patel, West Lafayette, IN (US); Carlo Scalo, West Lafayette, IN (US)

(73) Assignee: Purdue Research Foundation, West Lafayette, IN (US)

(21) Appl. No.: 16/190,103

(22) Filed: Nov. 13, 2018

Related U.S. Application Data
(60) Provisional application No. 62/585,138, filed on Nov. 13, 2017.

(51) Int. Cl. G06F 17/50; G01V 1/28; G01V 99/00

(52) U.S. Cl. CPC G06F 17/5036; G01V 99/005; G01V 1/282

(57) ABSTRACT

A non-transitory computer-readable medium encoded with a computer-readable program which, when executed by a processor, will cause a computer to execute a computational method, the computational method includes modeling acoustic properties at an orifice of a cavity using inverse integration, wherein the modeling includes transforming each linearized navier-stokes wave equation into a frequency domain by taking a Fourier transform. The modeling method additionally includes discretizing volume of the cavity. The modeling method further includes discretizing a set of linearized navier-stokes wave equations based on the volume of the cavity. Moreover, the modeling method includes collecting the each linearized navier-stokes wave equation into a matrix form, wherein the matrix form comprises a boundary value problem. Furthermore, the modeling method includes testing a range of frequencies at each discretized volume by using the each transformed linearized navier-stokes wave equation, wherein the testing the range of frequencies comprises calculating acoustic properties at each frequency of the range of frequencies.

### CROSS-REFERENCE TO RELATED APPLICATIONS

The present U.S. Patent Application is related to and claims the priority benefit of U.S. Provisional Patent Application Ser. No. 62/585,138, filed Nov. 13, 2017, the contents of which is hereby incorporated by reference in its entirety into this disclosure.

### STATEMENT OF GOVERNMENT SUPPORT

This invention was made with government support under FA9550-16-1-0209 awarded by the Air Force Office of Scientific Research (AFOSR). The government has certain rights in the invention.

### BACKGROUND

This section introduces aspects that may help facilitate a better understanding of the disclosure. Accordingly, these statements are to be read in this light and are not to be understood as admissions about what is or is not prior art.

Acoustic properties of a system are investigated via Helmholtz solvers, which rely on an eigenvalue formulation yielding a discrete set of complex eigenvalues and eigenvectors, containing frequency and growth rate, and resonant waveform information respectively. Such an approach requires homogeneous boundary conditions to be assigned everywhere (FIG. 1a). In an inviscid problem, for example, only the normal impedance needs to be specified at all boundaries to close the eigenvalue problem. In a thermoviscous problem, additional boundary conditions, related to the tangential components of velocity, and temperature, are need to be specified: they can be in the form of homogeneous Dirichlet or Neumann conditions such as slip/no-slip for the velocity, and isothermal/adiabatic for the temperature fluctuations, or, for example, be expressed as ratios of the frequency-transformed pressure to the tangential components of velocity (tangential impedance) or temperature. A classic eigenvalue approach therefore cannot be used to calculate the spatial distribution of the broadband impedance, for example, at the orifice of an acoustically absorptive cavity or the inlet of a nozzle.

### SUMMARY

Assigning homogeneous boundary conditions, such as acoustic impedance, to the thermoviscous wave equations (TWE) derived by transforming the linearized Navier-Stokes equations (LNSE) to the frequency domain results in a Helmholtz solver, whose output is a discrete set of complex eigenfunction and eigenvalue pairs. Various embodiments of the present application relate to an inverse Helmholtz solver (iHS) methodology, which reverses such procedure by returning the accurate spatial reconstruction of the acoustic impedance at the impedance boundary (IB) of a given domain via spatial integration of the linear TWE for a given real-valued frequency with assigned boundary conditions on other boundaries. The iHS procedure is implemented via continuous Galerkin spectral element method based discretization of the linear TWEs on an unstructured grid. Various embodiments relate to the development of iHS for two-dimensional problems with linear acoustics in this work. Upon prescription of the complex pressure waveform at the IB, the iHS solver returns the complex velocity and temperature fields within the cavity, as well as the IB, thus returning the acoustic and thermal impedance at the IB. For various frequencies, the iHS solver yields complete broadband complex impedance distribution at the IBs for any desired frequency range. The iHS approach is validated against Rott's thermoviscous wave propagation theory for inviscid and viscous ducts. Furthermore, various embodiments utilize fully compressible Navier Stokes simulations to validate the iHS methodology for thermoacoustically unstable cavities, geometrically complex cavities, and an array of Helmholtz resonators subject to a fully developed laminar flow modelling an acoustically lined duct. The iHS methodology is contingent upon prescription of accurate pressure closure condition at the IB limited to linear acoustics but unlimited in capacity to capture wave propagation in complex geometries.

A non-transitory computer-readable medium encoded with a computer-readable program which, when executed by a processor, will cause a computer to execute a computational method, the computational method includes modeling acoustic properties at an orifice of a cavity using inverse integration, wherein the modeling includes transforming each linearized navier-stokes wave equation into a frequency domain by taking a Fourier transform. The modeling method additionally includes discretizing volume of the cavity. The modeling method further includes discretizing a set of linearized navier-stokes wave equations based on the volume of the cavity. Moreover, the modeling method includes collecting the each linearized navier-stokes wave equation into a matrix form, wherein the matrix form comprises a boundary value problem. Furthermore, the modeling method includes testing a range of frequencies at each discretized volume by using the each transformed linearized navier-stokes wave equation, wherein the testing the range of frequencies comprises calculating acoustic properties at each frequency of the range of frequencies.

A non-transitory computer-readable medium encoded with a computer-readable program which, when executed by a processor, will cause a computer to execute a computational method, the computational method includes modeling acoustic properties at an orifice of a cavity using inverse integration, wherein the modeling includes transforming each linearized navier-stokes wave equation into a frequency domain by taking a Fourier transform. The modeling method additionally includes discretizing volume of the cavity. The modeling method further includes discretizing a set of linearized navier-stokes wave equations based on the volume of the cavity. Moreover, the modeling method includes collecting the each linearized navier-stokes wave equation into a matrix form, wherein the matrix form comprises a boundary value problem. The modeling method includes specifying a reference pressure and a reference amplitude based on an assumed phase distribution of pressure oscillations at the orifice of the cavity. Furthermore, the modeling method includes testing a range of frequencies at each discretized volume by using the each transformed linearized navier-stokes wave equation, wherein the testing the range of frequencies comprises calculating acoustic properties at each frequency of the range of frequencies.

A non-transitory computer-readable medium encoded with a computer-readable program which, when executed by a processor, will cause a computer to execute a computational method, the computational method includes transforming each linearized navier-stokes wave equation into a frequency domain by taking a Fourier transform. The method additionally includes discretizing volume of the cavity. The method further includes discretizing a set of linearized navier-stokes wave equations based on the volume of the cavity. Moreover, the method includes collecting the each linearized navier-stokes wave equation into a matrix form, wherein the matrix form comprises a boundary value problem. Furthermore, the method includes testing a range of frequencies at each discretized volume by using the each transformed linearized navier-stokes wave equation, wherein the testing the range of frequencies comprises calculating acoustic properties at each frequency of the range of frequencies.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry, various features may not be drawn to scale and are used for illustration purposes only. In fact, the dimensions of the various features in the drawings may be arbitrarily increased or reduced for clarity of discussion.

FIG. 1 illustrates differences between an eigenvalue-based Helmholtz solver and inverse Helmholtz solver methodology. FIG. 1A illustrates an eigenvalue-based Helmholtz solver methodology. FIG. 1B illustrates an inverse Helmholtz solver methodology.

FIG. 2 illustrates the unstructured spectral element method along with quadrature points on an arbitrary domain (left), transformation of a representative quadrilateral element (bottom right) along with the pressure closure condition vector at the IB (top right).

FIG. 3 illustrates acoustic pressure modes, Re (\hat{p}) inside cavities A (left) and B (right) obtained from the iHS for excitation frequencies of 40 kHz and planar closure conditions applied at the IB (a), unstructured quadrilateral element meshes used for both Navier-Stokes simulations and the iHS calculations (b), with coordinates in millimeters given in a table (c). FIG. 3A illustrates acoustic pressure modes, Re (\hat{p}) inside cavities A (left) and B (right) obtained from the iHS for excitation frequencies of 40 kHz and planar closure conditions applied at the IB. FIG. 3B illustrates acoustic pressure modes, Re (\hat{p}) inside cavities A (left) and B (right) obtained from the iHS for unstructured quadrilateral element meshes used for both Navier-Stokes simulations and the iHS calculations. FIG. 3C illustrates acoustic pressure modes, Re (\hat{p}) inside cavities A (left) and B (right) obtained from the iHS with coordinates in millimeters given in a table

FIG. 4 illustrates a computational set up for harmonic excitation and impedance extraction of the geometrically complex toy cavities with instantaneous pressure contours at steady state for |û_{∞}|=1.0/(ρ₀a₀) m/s in the case of the cavity B.

FIG. 5 illustrates spatial profiles of specific acoustic admittance obtained from the iHS (symbols) with a planar wave propagation assumption at the IB (a) and with DNS-driven closure conditions (c), compared with the impedance profiles extracted from pore-resolved Navier-Stokes simulations (lines) for excitation frequencies, ω/2π=20 kHz, 30 kHz, and 40 kHz, of cavity A, the toy cavity without wedges. The extracted DNS-driven closure conditions for the three frequencies are also shown (b). Table below shows the relative r.m.s error calculated for both real and imaginary parts of impedance Z_{*,IB}. FIG. 5A illustrates spatial profiles of specific acoustic admittance obtained from the iHS (symbols) with a planar wave propagation assumption at the IB (a) and with DNS-driven closure conditions. FIG. 5B illustrates extracted DNS-driven closure conditions for the three frequencies 20 kHz, 30 kHz, and 40 kHz. FIG. 5C spatial profiles of specific acoustic admittance obtained from the iHS (symbols) with a planar wave propagation assumption at the IB with the impedance profiles extracted from pore-resolved Navier-Stokes simulations (lines) for excitation frequencies, ω/2π=20 kHz, 30 kHz, and 40 kHz, of cavity A, the toy cavity without wedges. FIG. 5D illustrates the relative r.m.s error calculated for both real and imaginary parts of impedance Z_{*,IB}.

FIG. 6 illustrates initial setup (not to-scale) for the broadband wavepacket reflection off a toy cavity.

FIG. 7 illustrates comparisons between FIG. 7A real and FIG. 7B imaginary components of surface averaged acoustic impedance, and FIG. 7C absorption coefficient, β obtained from the iHS (∘) and approximations using the multi-oscillator fit (-) for cavities A and B. FIG. 7A illustrates real components of surface averaged acoustic impedance obtained from the iHS (∘) and approximations using the multi-oscillator fit (-) for cavities A and B. FIG. 7B illustrates imaginary components of surface averaged acoustic impedance obtained from the iHS (∘) and approximations using the multi-oscillator fit (-) for cavities A and B. FIG. 7C illustrates absorption coefficient β obtained from the iHS (∘) and approximations using the multi-oscillator fit (-) for cavities A and B.

FIG. 8 illustrates comparison of one-dimensional TDIBC simulations with IBC informed by iHS calculations ( ) against two dimensional fully resolved Navier-Stokes simulations (—): spatial distribution of acoustic pressure after one bounce-back time for cavity A(a) and cavity B(c), and instantaneous power at the IB for cavity A(b) and cavity B(d). FIG. 8A illustrates comparison of one-dimensional TDIBC simulations with IBC informed by his calculations against two-dimensional fully resolved Navier-Stokes simulations (—): spatial distribution of acoustic pressure after one bounce-back time for cavity A. FIG. 8B illustrates comparison of one-dimensional TDIBC simulations with IBC informed by his calculations against two-dimensional fully resolved Navier-Stokes simulations (—): spatial distribution of acoustic pressure after one bounce-back time for instantaneous power at the IB for cavity A. FIG. 8C illustrates comparison of one-dimensional TDIBC simulations with IBC informed by his calculations against two-dimensional fully resolved Navier-Stokes simulations (—): spatial distribution of acoustic pressure after one bounce-back time for cavity B. FIG. 8D illustrates comparison of one-dimensional TDIBC simulations with IBC informed by his calculations against two-dimensional fully resolved Navier-Stokes simulations (—): spatial distribution of acoustic pressure after one bounce-back time for instantaneous power at the IB for cavity B.

FIG. 9 illustrates one embodiment of an acoustic modeling system

FIG. 10 illustrates an exemplary mobile device or personal computer of the system of FIG. 9.

### DETAILED DESCRIPTION

The following disclosure provides many different embodiments, or examples, for implementing different features of the present application. Specific examples of components and arrangements are described below to simplify the present disclosure. These are examples and are not intended to be limiting. The making and using of illustrative embodiments are discussed in detail below. It should be appreciated, however, that the disclosure provides many applicable concepts that can be embodied in a wide variety of specific contexts. In at least some embodiments, one or more embodiment(s) detailed herein and/or variations thereof are combinable with one or more embodiment(s) herein and/or variations thereof.

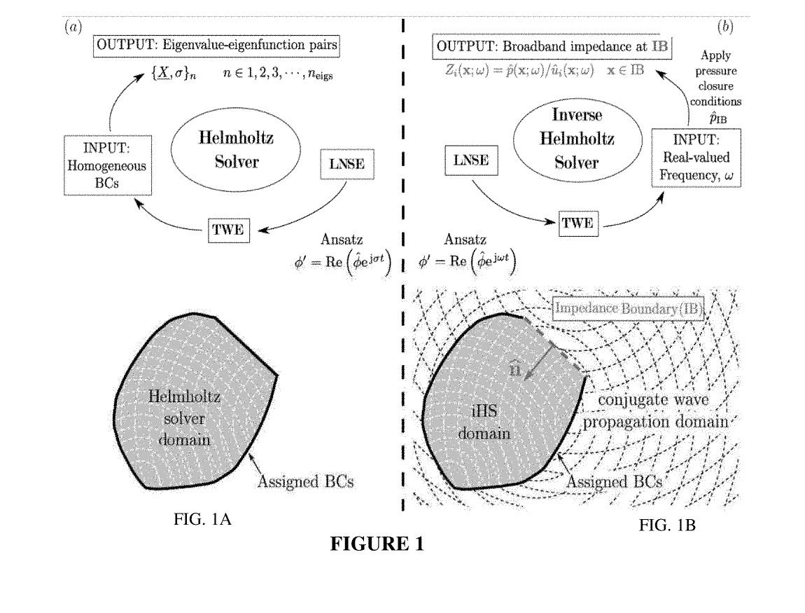

Various embodiments of the present disclosure relates an inverse Helmholtz solver (iHS), capable of deriving the spatial reconstruction of full broadband impedance on a given impedance boundary (IB) that separates two domains (FIG. 1b): (i) the isolable iHS domain, and (ii) the conjugate wave propagation domain. In one or more embodiments, the iHS is limited to a linear assumption and therefore nonlinear effects that would otherwise impact the impedance at the IB are neglected. Algebraically speaking some information concerning the wave propagation in the conjugate domain (FIG. 1b) is needed for closure of the iHS solver. No assumptions on the isentropic nature of the flow are made in the formulation of the iHS, according to at least one embodiment.

The iHS methodology presented herein does not belong to the class of inverse problems in acoustics that are concerned with the reconstruction of one or multiple acoustic sources from far field acoustic measurements. It is rather more appropriately classifiable as an inverse Cauchy problem applied to the thermoviscous-wave equations (TWE): the unknown, frequency-transformed solution at one or multiple boundaries is found by assigning an angular frequency ω and a phase distribution of either velocity or pressure fluctuations at said boundary with the solution being known on the other boundaries (and not necessarily homogeneous). Such problems are typically solved using iterative techniques and rely on an initial guess for the unknown boundary values that is updated until a given criterion is satisfied within a prescribed tolerance. Such methods are computationally expensive since they mandate the solution of a direct problem at each step, and may often not be able to satisfy the convergence criterion to the desired accuracy. The iHS methodology solves the inverse Cauchy problem applied to the linearized compressible Navier-Stokes equations via a one-time direct solution of a system of linear equations.

Calculation of the broadband acoustic impedance is one of the primary objectives in industrial scale acoustic and aeroacoustic problems such as sound absorption characteristics of acoustic liners, hypersonic boundary layer transition delay caused by porous walls, thermoacoustic instabilities in combustion chambers, and many others. Knowledge of broadband acoustic impedance (and thermal impedance) along with its spatial resolution could be insightful regarding the mechanisms of acoustic energy absorption or production by acoustic cavities. Various embodiments of the present application relate to the scalable capabilities of the iHS methodology to predict spatially resolved broadband acoustic impedance of acoustic liners.

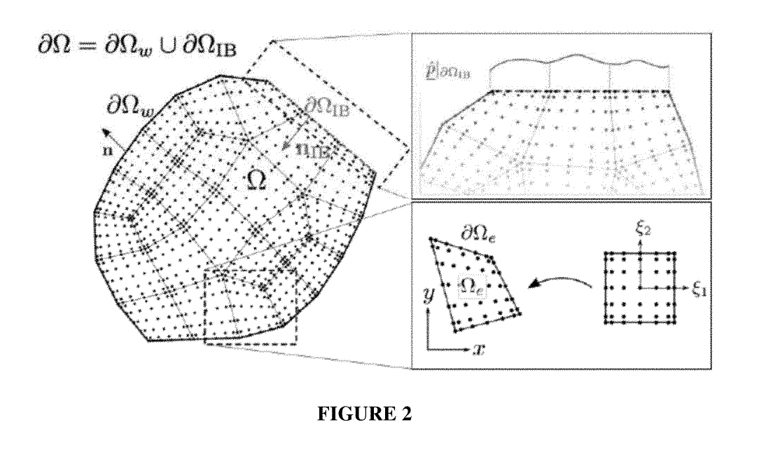

Various iHS methodologies presented herein evaluates the spatially resolved broadband acoustic impedance at the open surface of any given geometry without the use of regularization or data-driven techniques. Two key pieces of input to the iHS are the frequency of wave propagation, and the spatial distribution of pressure at the IB (FIG. 2), accuracy of which determines the accuracy of the evaluated impedance.

Various methodologies of modeling acoustic properties that use the iHS formulation are outlined. These utilize the linearized thermoviscous wave equations (TWE) derived from the linearized Navier Stokes equations (LNSE) and discretized on an unstructured grid using spectral elements method.

Using Linearized Navier-Stokes Equations (LNSE), the governing equations for a fully compressible flow are:

$$\frac{\partial }{\partial t} ( p ) + \frac{\partial }{\partial {x}_{k}} ( {pu}_{k} ) = 0 , \\ \frac{\partial }{\partial t} ( {pu}_{i} ) + \frac{\partial }{\partial {x}_{k}} ( \text{?} ) = - \frac{\partial p}{\partial {x}_{i}} + \frac{\partial {r}_{ik}}{\partial {x}_{k}} , \\ \frac{\partial }{\partial t} ( pE ) + \frac{\partial }{\partial {x}_{k}} [ {u}_{k} ( pE + p ) ] = \frac{\partial }{\partial {x}_{k}} ( {u}_{i} {\text{?}}_{ik} - {q}_{k} ) , \\ \text{?} \text{indicates text missing or illegible when filed}$$

where x₁, x₂, and x₃ (or x, y, and z) are Cartesian coordinates, uᵢ are the velocity field components in each of these directions, and p, ρ, and E are, respectively, the pressure, density, and total energy per unit mass. The stress tensor, τᵢₖ and heat flux qₖ are defined as,

$${τ}_{ik} = 2 μ [ \frac{1}{2} ( \frac{\partial {u}_{k}}{\partial \text{?}} + \frac{\partial \text{?}}{\partial {x}_{k}} ) ] + λ \frac{\partial {u}_{m}}{\partial {x}_{m}} {δ}_{ik} , {q}_{k} = - κ \frac{\partial T}{\partial {x}_{k}} , \\ \text{?} \text{indicates text missing or illegible when filed}$$

where μ and λ are the first and second viscosity coefficients, respectively, κ is the thermal conductivity, and T is the temperature. Throughout, we assume that Stokes hypothesis, λ=−2/3μ, is valid.

Decomposing all variables in the above given equations into a base state, denoted with the subscript (0), and a fluctuation, denoted with the superscript (′) and linearizing, yields

$$\frac{\partial {ρ}^{′}}{\partial t} + \frac{\partial ( {ρ}_{0} {u}_{k}^{′} )}{\partial {x}_{k}} + \frac{\partial ( {u}_{0} , k {ρ}^{′} )}{\partial {x}_{k}} = 0 , \\ {ρ}_{0} \frac{\partial {u}_{t}^{′}}{\partial t} + \text{?} \frac{\partial {ρ}^{′}}{\partial t} + \frac{\partial \text{?}}{\partial {x}_{k}} + \frac{\partial \text{?}}{\partial {x}_{k}} + \frac{\partial \text{?}}{\partial {x}_{k}} = - \frac{\partial {p}^{′}}{\partial {x}_{t}} + \frac{\partial }{\partial {x}_{t}} \text{?} , \\ {ρ}_{0} \frac{\partial {E}^{′}}{\partial t} + {E}_{0} \frac{\partial {ρ}^{′}}{\partial t} + \frac{\partial \text{?}}{\partial {x}_{k}} + \frac{\partial \text{?}}{\partial {x}_{k}} + \frac{\partial \text{?}}{\partial {x}_{k}} + {p}_{0} \frac{\partial {u}_{k}^{′}}{\partial {x}_{k}} + {p}^{′} \frac{\partial \text{?}}{\partial {x}_{k}} = κ \frac{\partial }{\partial {x}_{k}} ( \frac{\partial {T}^{′}}{\partial {x}_{k}} ) + \frac{\partial }{\partial {x}_{k}} ( \text{?} + \text{?} ) . \\ \text{?} \text{indicates text missing or illegible when filed}$$

where E′ and τ′ᵢₖ are perturbations in total energy and stress tensor, given by,

$${E}^{′} = {e}^{′} + \text{?} {u}_{t}^{′} , {τ}_{ik}^{′} = μ [ ( \frac{\partial {u}_{k}^{′}}{\partial \text{?}} + \frac{\partial {u}_{t}^{′}}{\partial {x}_{k}} ) - \frac{2}{3} \frac{\partial {u}_{m}^{′}}{\partial {x}_{m}} {δ}_{ik} ] , \\ \text{?} \text{indicates text missing or illegible when filed}$$

and where e′ is the perturbation in the internal energy. In general, the conjugate wave propagation domain is assumed to have negligible mean flow, u_{0,i}/a₀<<1—where a₀ is speed of sound—allowing for the approximation of a quiescent base state with only small perturbations corresponding to linear acoustic wave propagation in the iHS domain. Furthermore, applying thermally and calorically perfect gas assumptions yield,

$${d}_{p} = \frac{{p}_{0}}{{ρ}_{0}} d ρ + \frac{{p}_{0}}{{T}_{0}} dT , and d \text{?} = {c}_{v} dT , \\ \text{?} \text{indicates text missing or illegible when filed}$$

where cᵥ is the specific heat at constant volume of the fluid inside the domain. Finally, neglecting any base state gradients in viscosity to arrive at the equations:

$$\frac{{ρ}_{0}}{{p}_{0}} \frac{\partial {p}^{′}}{\partial t} - \frac{{ρ}_{0}}{{T}_{0}} \frac{\partial {T}^{v}}{\partial t} + {ρ}_{0} \frac{\partial {u}_{k}^{′}}{\partial {x}_{k}} + {u}_{k}^{′} \frac{\partial {ρ}_{0}}{\partial {x}_{k}} = 0 , \\ {ρ}_{0} \frac{\partial {u}_{t}^{′}}{\partial t} + \frac{\partial {p}^{′}}{\partial \text{?}} - μ \frac{{\partial }^{2} {u}_{i}^{′}}{\partial {x}_{k}^{2}} - \frac{1}{3} μ \frac{{\partial }^{2} {u}_{k}^{′}}{\partial {x}_{k} \partial {x}_{i}} = 0 , \\ {ρ}_{0} {c}_{v} \frac{\partial {T}^{′}}{\partial t} + {ρ}_{0} {c}_{v} {u}_{k}^{′} \frac{\partial {T}_{0}}{\partial {x}_{k}} + {p}_{0} \frac{\partial {u}_{k}^{′}}{\partial {x}_{k}} - κ \frac{{\partial }^{2} \text{?}}{\partial {x}_{k}^{2}} = 0 , \\ \text{?} \text{indicates text missing or illegible when filed}$$

govern small perturbations in a quiescent medium and are hereafter referred to as the Linearized Navier-Stokes Equations (LNSE). The final methodology is independent of the assumptions which yield the above equations and can easily be extended to account for mean flow, real fluid effects, and base gradients of viscosity.

Transforming the equations above from time domain to frequency domain according to the convention, φ′(x; t)=Re(\hat{φ}(x; ω)e^{jωt}, where φ represents the solved variables in the equation, i.e., p, T, or uᵢ, the thermoviscous wave equations (TWE) are obtained:

$$j ω \frac{{ρ}_{0}}{{p}_{0}} \hat{p} - j ω \frac{{ρ}_{0}}{{T}_{0}} \hat{T} + {ρ}_{0} \frac{\partial {\hat{u}}_{k}}{\partial {x}_{k}} + {\hat{u}}_{k} \frac{\partial {ρ}_{0}}{\partial {x}_{k}} = 0 , \\ j {ωρ}_{0} {\hat{u}}_{i} + \frac{\partial \hat{p}}{\partial {x}_{i}} - μ \frac{{\partial }^{2} {\hat{u}}_{i}}{\partial {x}_{k}^{2}} - \frac{1}{3} μ \frac{{\partial }^{2} {\hat{u}}_{k}}{\partial {x}_{i} \partial {x}_{k}} = 0 , \\ j ω \text{?} {c}_{v} \hat{T} + {ρ}_{0} \text{?} {\hat{u}}_{k} \frac{\partial {T}_{0}}{\partial {x}_{k}} + {p}_{0} \frac{\partial {\hat{u}}_{k}}{\partial {x}_{k}} - κ \frac{{\partial }^{2} \hat{T}}{\partial {x}_{k}^{2}} = 0 , \\ \text{?} \text{indicates text missing or illegible when filed}$$

The above govern the wave propagation phenomenon in the iHS domain, comprising of a stagnant and ideal fluid as per the assumptions made in the previous section. One or more embodiments relate only on two-dimensional geometrically complex iHS domains, i.e. Ω ∈ [symbol] ². Furthermore, as part of this description, the iHS equations are developed using a spectral elements method and Galerkin projection. Within each mesh element Ωₑ, the polynomial expansion of variables \hat{T}, û, \hat{v}, and \hat{p} follow as,

$$\hat{T} = {\sum }_{n = 0}^{P} {\hat{T}}_{n}^{e} {φ}_{n}^{e} ( x , y ) , \hat{p} = {\sum }_{n = 0}^{P} {\hat{p}}_{n}^{e} {φ}_{n}^{e} ( x , y ) , \hat{u} = {\sum }_{n = 0}^{P} {\hat{u}}_{n}^{e} {φ}_{n}^{e} ( x , y ) , \\ \hat{v} = {\sum }_{n = 0}^{P} {\hat{v}}_{n}^{e} {φ}_{n}^{e} ( x , y )$$

where ϕₙ^{e}(x, y) are the polynomials inside the element Ωₑ and the element boundaries ∂Ωₑ representing interior, boundary, and the vertex modes, and the variables \hat{T}ₙ^{e}, \hat{p}ₙ^{e}, ûₙ^{e}, and \hat{v}ₙ^{e} are the polynomial expansion coefficients of the respective variable. P is the highest degree of orthogonal polynomials used in the expansions. Polynomials ϕₙ^{e}(x, y) are defined such that C⁰ continuity is maintained at element intersection. Substituting equation these expansions in the previous equations, and projecting on the space of polynomials ϕₘ^{e}(x, y), the weak form of TWE equations within an element Ωₑ are obtained,

$$j ω \frac{1}{{p}_{0}} {M}_{mn}^{e} {\hat{p}}_{n}^{e} - j ω \frac{1}{{T}_{0}} {M}_{mn}^{e} {\hat{T}}_{n}^{e} + {C}_{x , mn}^{e , 1} {\hat{u}}_{n}^{e} + {C}_{y , mn}^{e , 1} {\hat{v}}_{n}^{e} - {Θ}_{x , mn}^{e} {\hat{u}}_{n}^{e} - {Θ}_{y , mn}^{e} {\hat{v}}_{n}^{e} = 0 , \\ j {ωρ}_{0} {M}_{mn}^{e} {\hat{u}}_{n}^{e} + {C}_{x , mn}^{e , 1} {\hat{p}}_{n}^{e} - {ρΓ}_{u , m}^{e} - μ {L}_{mn}^{e} {\hat{u}}_{n}^{e} - \frac{μ}{3} {C}_{xx , mn}^{e , 2} {\hat{u}}_{n}^{e} - \frac{μ}{3} {C}_{xy , mn}^{e , 2} {\hat{v}}_{n}^{e} = 0 , \\ j {ωρ}_{0} {M}_{mn}^{e} {\hat{v}}_{n}^{e} + {C}_{y , mn}^{e , 1} {\hat{p}}_{n}^{e} - {ρΓ}_{v , m}^{e} - μ {L}_{mn}^{e} {\hat{v}}_{n}^{e} \frac{μ}{3} {C}_{yy , mn}^{e , 2} {\hat{v}}_{n}^{e} - \frac{μ}{3} {C}_{xy , mn}^{e , 2} {\hat{u}}_{n}^{e} = 0 , \\ j {ωρ}_{0} \text{?} {M}_{mn}^{e} {\dot{T}}_{n}^{e} + {p}_{0} {C}_{x , mn}^{e , 1} {\hat{u}}_{n}^{e} + {p}_{0} {C}_{y , mn}^{e , 1} {\hat{v}}_{n}^{e} - {κΓ}_{T , m}^{e} - κ {L}_{mn}^{e} {\hat{T}}_{n}^{e} + \frac{{p}_{0} {c}_{v}}{R} {Θ}_{x , mn}^{e} {\hat{u}}_{n}^{e} + \frac{{p}_{0} {c}_{u}}{R} {Θ}_{y , mn}^{e} {\hat{v}}_{n}^{e} = 0 , \\ where , \\ {M}_{mn}^{e} = {\int }_{{Ω}_{x}}^{ } {φ}_{m}^{e} {φ}_{n}^{e} dxdy , {L}_{mn}^{e} = {\int }_{{Ω}_{x}}^{ } ∇ {φ}_{m}^{e} \cdot ∇ {φ}_{n}^{e} dxdy , \\ {Θ}_{x , mn}^{e} = {\int }_{{Ω}_{x}}^{ } {φ}_{m}^{e} {φ}_{n}^{e} \frac{1}{{T}_{0}} \frac{\partial {T}_{0}}{\partial x} dxdy , {Θ}_{y , mn}^{e} = {\int }_{{Ω}_{x}}^{ } {φ}_{m}^{e} {φ}_{n}^{e} \frac{1}{{T}_{0}} \frac{\partial {T}_{0}}{\partial y} dxdy , \\ {C}_{x , mn}^{e , 1} = {\int }_{{Ω}_{x}}^{ } {φ}_{m}^{e} \frac{\partial {φ}_{n}^{e}}{\partial x} dxdy , {C}_{y , mn}^{e , 1} = {\int }_{{Ω}_{x}}^{ } {φ}_{m}^{e} \frac{\partial {φ}_{n}^{e}}{\partial y} dxdy , \\ {C}_{xx , mn}^{e , 2} = {\int }_{{Ω}_{x}}^{ } {φ}_{m}^{e} \frac{{\partial }^{2} {φ}_{n}^{e}}{\partial {x}^{2}} dxdy , {C}_{yy , mn}^{e , 2} = {\int }_{{Ω}_{x}}^{ } {φ}_{m}^{e} \frac{{\partial }^{2} {φ}_{n}^{e}}{\partial {y}^{2}} dxdy , \\ {C}_{xy , mn}^{e , 2} = {\int }_{{Ω}_{x}}^{ } {φ}_{m}^{e} \frac{{\partial }^{2} {φ}_{n}^{e}}{\partial x \partial y} dxdy , {Γ}_{u , m}^{e} = {\int }_{\partial Ω ⋂ \partial {Ω}_{x}}^{ } {φ}_{m}^{e} ( n \cdot ∇ u ) dxdy , \\ {Γ}_{v , m}^{e} = {\int }_{\partial Ω ⋂ \partial {Ω}_{x}}^{ } {φ}_{m}^{e} ( n \cdot ∇ v ) dxdy , {Γ}_{T , m}^{e} = {\int }_{\partial Ω ⋂ \partial {Ω}_{x}}^{ } {φ}_{m}^{e} ( n \cdot ∇ T ) dxdy . \\ \text{?} \text{indicates text missing or illegible when filed}$$

In the above equations, ∂Ω refers to the total boundary of the iHS domain, Ω, so that ∂Ω=∂Ω_{w} ∪ ∂Ω_{IB}, where IB refers to the unknown impedance boundary. Note that while all geometries analyzed in the present application are discretized with quadrilateral type elements only, the iHS methodology is independent of choice of element type or the overlying numerical methodology. Such equations can be developed and combined for all the elements, Ωₑ ∈ Ω, utilizing the C⁰ continuity of the polynomials ϕₙ^{e} at inter-element boundaries. The assembled system of equations along with appropriate boundary conditions on ∂Ω_{w} constitute an unclosed system if the boundary conditions on the IB remain unspecified. In the upcoming paragraphs, iHS methodology is outlined in which these equations are solved at the IB, assigning the complex pressure modes at the IB,

\hat{p}_{∂Ω}_{ₘ}=\hat{p}_{IB}(x, y), x, y ∈ ∂Ω_{IB}.

This yields, complex amplitudes of velocity, û, \hat{v} and temperature, \hat{T} at the IB.

Here the present application outlines the assembly of the algebraic system implementing the iHS methodology. Weak form of the linearized continuity, momentum, and energy equations are solved in the domain Ω. The iHS requires the assignment of a pressure profile \hat{p}|_{IB} and a real valued frequency ω as inputs, which govern the linear acoustic field within the domain Ω as well as at the IB, Ω_{IB}. Temperature and velocity fields at the IB are then obtained as part of the solution. To assign the complex boundary modes of pressure, \hat{p}_{IB} at the unknown impedance boundary, Ω_{IB} we replace the corresponding continuity equation terms with the complex boundary modes of pressure \hat{p}_{IB}. Following matrix equations summarizes the global assembly of the elemental TWE,

A^{e}X^{e}=F^{e},

where,

$${{A}_{\underline{\_}}}^{e} = ( \begin{matrix}j ω \frac{1}{{p}_{0}} {{M}_{\underline{\_}}}^{e} & {{C}_{x}^{e}}_{\underline{\_}} - {{Θ}_{x}^{e}}_{\underline{\_}} & {{C}_{y}^{e}}_{\underline{\_}} - {{Θ}_{y}^{e}}_{\underline{\_}} & - j ω \frac{1}{{T}_{0}} {{M}_{\underline{\_}}}^{e} \\ {{C}_{x}^{e}}_{\underline{\_}} & j ω {ρ}_{0} {{M}_{\underline{\_}}}^{e} - μ {{L}_{\underline{\_}}}^{e} - \frac{μ}{3} {{C}_{xx}^{e , 2}}_{\underline{\_}} & - \frac{μ}{3} {{C}_{zy}^{e , 2}}_{\underline{\_}} & {0}_{\underline{\_}} \\ {{C}_{y}^{e}}_{\underline{\_}} & - \frac{μ}{3} {{C}_{zy}^{e , 2}}_{\underline{\_}} & j ω {ρ}_{0} {{M}_{\underline{\_}}}^{e} - μ {{L}_{\underline{\_}}}^{e} - \frac{μ}{3} {{C}_{yy}^{e , 2}}_{\underline{\_}} & {0}_{\underline{\_}} \\ {0}_{\underline{\_}} & {p}_{0} {{C}_{z}^{e}}_{\underline{\_}} + \text{?} {{Θ}_{z}^{e}}_{\underline{\_}} & {p}_{0} {{C}_{y}^{e}}_{\underline{\_}} + \text{?} {{Θ}_{y}^{e}}_{\underline{\_}} & j {ωρ}_{0} {c}_{v} {{M}_{\underline{\_}}}^{e} - κ {{L}_{\underline{\_}}}^{e}\end{matrix} ) , \\ {{X}_{\underline{\_}}}^{e} = ( \begin{matrix}{\underline{\hat{p}}}^{e} \\ {\underline{\hat{u}}}^{e} \\ {\underline{\hat{v}}}^{e} \\ {\underline{\hat{T}}}^{e}\end{matrix} ) , {{F}_{\underline{\_}}}^{e} = ( \begin{matrix}\underline{B} \\ μ {\underline{Γ}}_{u}^{e} \\ μ {\underline{Γ}}_{v}^{e} \\ μ {\underline{Γ}}_{T}^{e}\end{matrix} ) , \\ \text{?} \text{indicates text missing or illegible when filed}$$

where the (m, n)^{th} component of matrices M^{e}, Cₓ^{e}, C_{y}^{e}, L^{e}, Θₓ^{e}, Θ_{y}^{e}, Cₓₓ^{e,2}, C_{xy}^{e,2}, C_{yy}^{e,2}, and m^{th} components of the arrays Γᵤ^{e}, Γᵥ^{e}, and Γ_{T}^{e} are given in the previous section. The boundary modes of \hat{p} in the elements adjacent to the impedance boundary ∂Ω_{IB} are substituted in the F^{e} array of the element at the respective modal indices inside the array B, thus replacing only the continuity equation at these indices only. Consequently, the global assembly of the system of equations representing the iHS methodology reads,

$$( \begin{matrix}{{A}_{\underline{\_}}}^{1} & ⋯ & ⋯ & ⋯ & {0}_{\underline{\_}} \\ ⋮ & {{A}_{\underline{\_}}}^{e - 1} & ⋱ & ⋱ & ⋮ \\ ⋮ & ⋱ & {{A}_{\underline{\_}}}^{e} & ⋱ & ⋮ \\ ⋮ & ⋱ & ⋱ & {{A}_{\underline{\_}}}^{e + 1} & ⋮ \\ {0}_{\underline{\_}} & ⋯ & ⋯ & ⋯ & {{A}_{\underline{\_}}}^{N}\end{matrix} ) ( \begin{matrix}{\underline{X}}^{1} \\ ⋮ \\ {\underline{X}}^{e - 1} \\ {\underline{X}}^{e} \\ {\underline{X}}^{e + 1} \\ ⋮ \\ {\underline{X}}^{N}\end{matrix} ) = ( \begin{matrix}{\underline{F}}^{1} \\ ⋮ \\ {\underline{F}}^{e - 1} \\ {\underline{F}}^{e} \\ {\underline{F}}^{e + 1} \\ ⋮ \\ {\underline{F}}^{N}\end{matrix} ) .$$

At ∂Ω_{w}, hard wall no-slip boundary conditions can be applied on û and \hat{v},

û=0, \hat{v}=0, at ∂Ω_{w}.

For \hat{T}, isothermal walls correspond to homogeneous Dirichlet conditions,

\hat{T}=0, at ∂Ω_{w},

and adiabatic walls correspond to homogeneous Neumann conditions,

∇\hat{T}·n=0, at ∂Ω_{w},

where n is the outward normal at ∂Ω_{IB}. This concludes the construction of the iHS problem. A solution consists of complex pressure, temperature, and velocity fields inside and at all boundaries of the domain. A wall-normal impedance at the IB is then given by,

$${Z}_{n \vert \partial {Ω}_{m}} = \frac{\text{?}}{[ \hat{u} , \hat{v} ] \cdot {n}_{IB}} , \\ \text{?} \text{indicates text missing or illegible when filed}$$

where n_{IB} is the inward normal at the IB.

The iHS methodology is independent of the number or orientations IB. Moreover, the methodology does not mandate the specification of any one kind of pressure distribution at the IB. Test cases reveal that the accuracy of the evaluated impedance is contingent upon specification of accurate pressure distribution at the IB, which in turn can be obtained from analytical or precursor calculations or could be approximated as planar for certain quasi-1D cases.

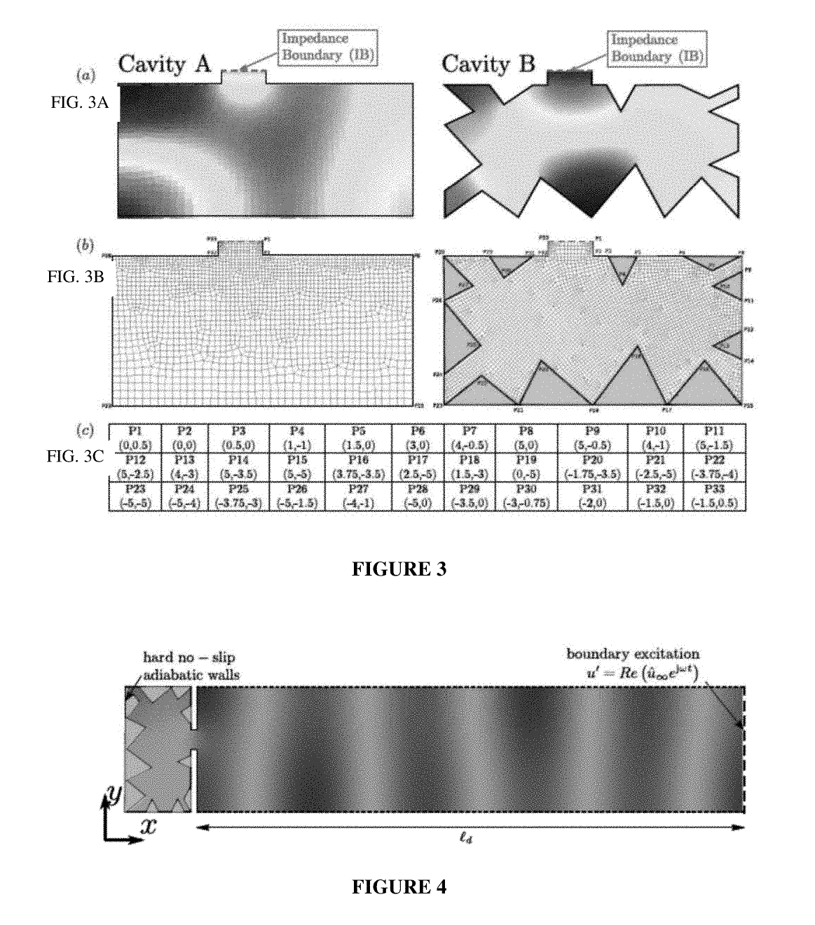

Two geometrically complex toy cavities (FIG. 3), one with a simple rectangular shape (Cavity A), and the other with internal wedges (Cavity B) are investigated using the iHS. Both the cavity volumes are arranged asymmetrically with respect to the cavity necks. The details of the cavity geometries are also given in the below paragraphs. Impedance at the open end (IB) of the toy cavities obtained from the iHS is compared with that extracted from fully compressible Navier-Stokes simulations of harmonic excitation of the cavities. Finally, application of the iHS methodology to inform the modeling of acoustic cavities as lumped impedance boundaries is discussed and its effectiveness is demonstrated. To this end, the present application describes a broadband pulse reflection, of the fully resolved cavities first, and then of an equivalent time-domain impedance boundary condition (TDIBC) defined utilizing the iHS-educed impedance, fitted with a set of causal oscillators

A choice of two cavity geometries is intended to demonstrate the accuracy of acoustic impedance predicted by the iHS compared with the fully resolved Navier-Stokes simulations for asymmetrical complex shaped cavities. Accuracy of impedance is assessed utilizing the planar pressure closure conditions, as well as the true pressure closure conditions obtained from the fully resolved Navier-Stokes simulations.

The geometries and the unstructured meshes of the analyzed two-dimensional toy cavities are shown in FIG. 3(b); (c). For Cavity A, the mesh consists of 1907 quadrilateral elements and for Cavity B, the mesh consists of 3884 quadrilateral elements. The iHS results are shown for highest degree P=5. Momentum perturbations vanish at the walls of the cavities, because of which oscillating boundary layers (Stokes boundary layers) develop. Outside the cavity, a long waveguide is used to direct the imposed acoustic perturbations towards the cavity. The length of the waveguide, [symbol] _{d} (FIG. 4), does not impact the evaluated impedance. A value of [symbol] _{d}=100 mm is chosen to accommodate the initialized wavepacket, considered in the TDIBC test case. Test cases in the following subsections assume a viscous medium at atmospheric base pressure and temperature T₀=300 K for air, modeled as an ideal gas. Dynamic viscosity is evaluated using Sutherland's law with an augmented reference viscosity, μ_{ref}=1.827 e⁻³ kg·(m·s)⁻¹ to reduce grid resolution requirements. FIG. 3(a) shows contours of acoustic pressure (Re(\hat{p})) inside the two cavities, evaluated using the iHS for excitation frequencies of ω/2π=40 kHz and planar pressure closure conditions. The acoustic field obtained from the iHS resolves the perturbations inside the cavities. Consequently, the impedance obtained at the IB accounts for the geometrically complex features of the cavity.

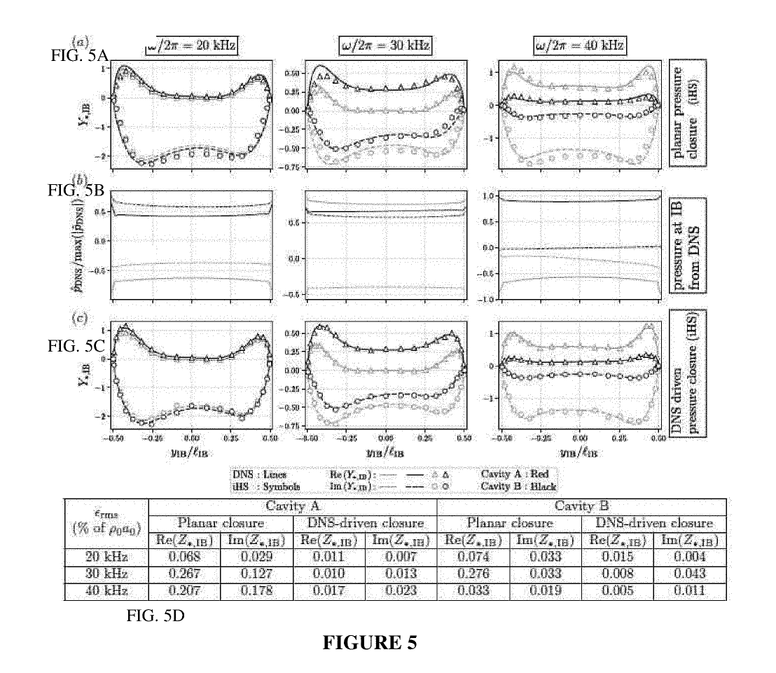

FIG. 4 shows the computational set up used for extracting the acoustic impedance at the mouth of the cavities corresponding to the impedance boundary, IB from the steady state response of a harmonic acoustic excitation of the cavity. The right boundary of the waveguide (FIG. 4) is defined as an inlet condition with harmonic perturbations in x-velocity, u₀. Symmetry boundary conditions are imposed on the lateral walls of the waveguide (dashed lines). We consider three frequencies (20 kHz, 30 kHz, 40 kHz) of harmonic excitation in the current study and compare the results obtained from the iHS and the Navier-Stokes simulations. In the latter, the Fourier amplitudes of acoustic pressure and velocity perturbations at the IB (\hat{p}; û) are extracted to evaluate the acoustic impedance. Due to the cavity geometry, pressure fluctuations are non-planar at the IB (FIG. 5). The iHS methodology does not assume (nor require the assignment of) any specific pressure distribution at the impedance boundary, which allows us to compare two different closure conditions for the iHS: (i) planar wave closure conditions corresponding to ∂\hat{p}/∂x=0 at the IB, and (ii) DNS-driven closure conditions derived from the pore-resolved Navier-Stokes simulations, which are discussed below (FIG. 5(b)). The application of a planar wave closure condition causes a minor mismatch in the spatial profiles of specific acoustic admittance (FIG. 5a) when compared to those extracted from pore-resolved simulations for all cavities and frequencies considered. Upon utilizing the non-planar pressure closure conditions (FIG. 5(b)) the deviations in the admittance obtained from the iHS methodology compared to those from Navier-Stokes simulations decrease significantly (FIG. 5(c)), thus diminishing the relative error ϵᵣₘₛ, as shown in the tables in FIG. 5.

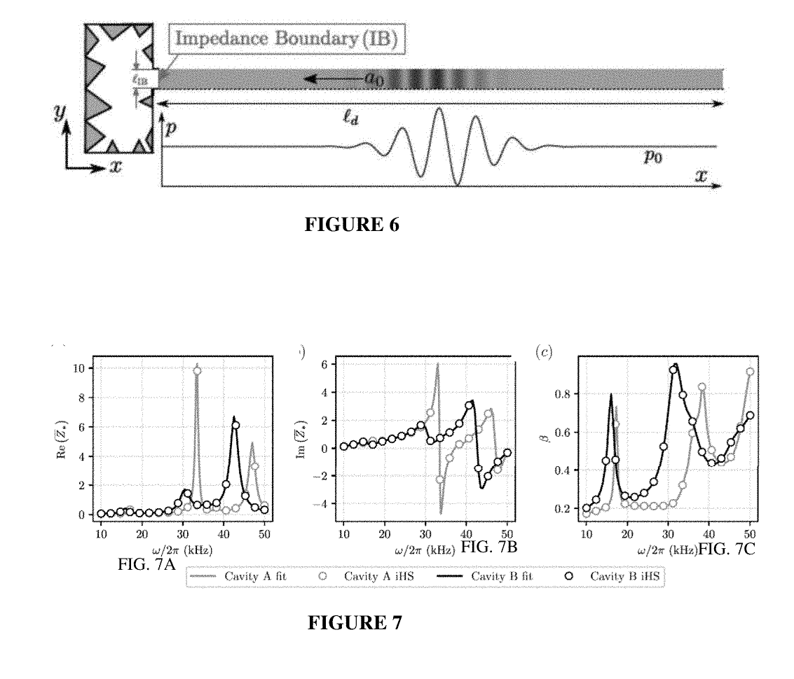

Utilizing iHS results for planar pressure closure conditions, a broadband wavepacket reflection is studied with the cavity modeled as an equivalent TDIBC and compared with cavity resolved calculations. The latter are initialized with a left traveling broadband acoustic wavepacket (FIG. 6), for which the initial conditions are given by,

$${p}^{′} = {A}_{0} {e}^{- 4000 {( x - x )}^{2}} sin ( 2 π kx ) , {v}^{′} = - \frac{{p}^{′}}{{ρ}_{0} {a}_{0}} , {ρ}^{′} = {p}^{′} / {a}_{0}^{2} , and$$

$${T}^{′} = \frac{1}{{ρ}_{0} \text{?}} {p}^{′} - \frac{{T}_{0}}{{ρ}_{0}} {ρ}^{′} , \\ \text{?} \text{indicates text missing or illegible when filed}$$

with A₀=1 Pa, k=180 m⁻¹, and x̅=0.05 m.

For modeling the cavity as a TDIBC, broadband surface averaged acoustic impedance from the iHS was used to evaluate discrete wall softness, Ŝ(ω), which was then fit to a multi-oscillator impedance model,

$$\hat{S} ( ω ) = \frac{2}{1 + {\overline{Z}}_{*} ( ω )} = {\sum }_{k = 1}^{{n}_{*}} [ \frac{{μ}_{k}}{j ω - {p}_{k}} + \frac{{μ}_{k}^{*}}{j ω - {p}_{k}^{*}} ] ,$$

where Z̅_{*}(ω) is the surface-averaged acoustic impedance,

$${\overline{Z}}_{*} ( ω ) = \frac{1}{{l}_{IB}} {\int }_{IB}^{ } {Z}_{*} dy ,$$

in the frequency range of 10-50 kHz, bracketing the frequency content of the initialized wave packet. In the context of the presented model, obtaining a fit involves the evaluation of complex poles (pₖ) and residues (μₖ) that allow to fit the given wall softness to an arbitrary accuracy. In the present study, the fit has been performed using the sequential least squares programming (SLSQP) minimization functionality of Python's SCIPY library.

Starting with an initial guess for the number and values (real and imaginary components) of poles and residues, the algorithm iteratively adds or removes oscillators while altering their values to obtain a fit that is 98% accurate. Computational setup utilized for validating the TDIBC simulations is modified such that the width of the waveguide is equal to the width of the neck or the IB ( [symbol] _{IB}), as shown in FIG. 6. Such modification is necessary since only the cavity impedance is considered in the surface averaging. However, in the original setup for the DNS solver (see FIG. 4), the hard walls of the resonator in the plane of the IB result in wave reflections which cause non-planar wave propagation inside the waveguide.

FIG. 7 compares the results obtained from the iHS with the multi-oscillator fit that is obtained by fitting the model in the target frequency range. One sees that there is excellent agreement in the impedances recovered using the evaluated poles and residues with the actual discrete data provided by the iHS. Note that only one out of every five data points in the frequency domain from the iHS have been plotted in FIG. 7 for clarity. FIG. 7 also showcases the absorption coefficients for the two cavities,

$$β ( ω ) = 1 - {\vert \frac{1 - {Z}_{*} ( ω )}{1 + {Z}_{*} ( ω )} \vert}^{2} ,$$

with cavity B being more absorptive than cavity A. The presence of wedges, in fact, increases the overall surface area available for thermoviscous attenuation of acoustic waves.

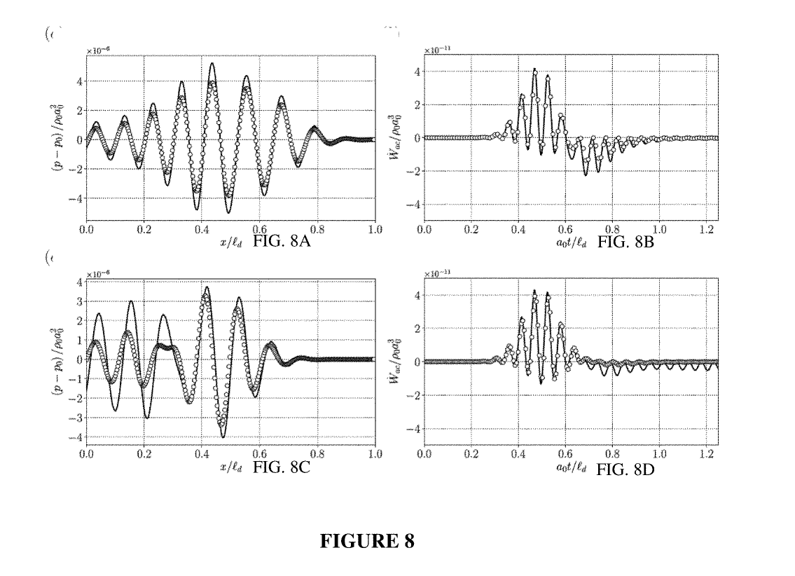

FIGS. 8(a) and (c) compare the spatial profiles of acoustic pressure from one-dimensional TDIBC calculations and pore-resolved simulations after one reflection for cavity A and B respectively. The mismatch in the wave reflection highlights the limitations of one-dimensional approximation in the TDIBC simulations. Temporal variation of the acoustic power \dot{W}_{ac} at the IB is shown in FIGS. 8(b) and (d).

### EXAMPLE 1

A non-transitory computer-readable medium encoded with a computer-readable program which, when executed by a processor, will cause a computer to execute a computational method, the computational method includes modeling acoustic properties at an orifice of a cavity using inverse integration, wherein the modeling includes transforming each linearized navier-stokes wave equation into a frequency domain by taking a Fourier transform. The modeling method additionally includes discretizing volume of the cavity. The modeling method further includes discretizing a set of linearized navier-stokes wave equations based on the volume of the cavity. Moreover, the modeling method includes collecting the each linearized navier-stokes wave equation into a matrix form, wherein the matrix form comprises a boundary value problem. Furthermore, the modeling method includes testing a range of frequencies at each discretized volume by using the each transformed linearized navier-stokes wave equation, wherein the testing the range of frequencies comprises calculating acoustic properties at each frequency of the range of frequencies. In some embodiments, there are one or more orifices. In some embodiments, the cavity is at least one of any shape, any volume, or any topology.

In one or more embodiments, the collecting the each linearized navier-stokes wave equation into the matrix form includes specifying a reference pressure and a reference amplitude based on an assumed phase distribution of pressure oscillations at the orifice of the cavity.

In one or more embodiments, the transforming the each linearized navier-stokes wave equations based on the cavity includes applying known boundary conditions to the cavity to the set of linearized navier-stokes equations; and extending the set of linearized navier-stokes wave equations at the orifice of the cavity. In some embodiments, the known boundary conditions are applied to a cavity boundaries of the cavity, but not the orifice.

In one or more embodiments, the testing the range of frequencies of the each discretized volume by using the each transformed linearized navier-stokes wave equation includes evaluating impedance of acoustic waves within an entirety of the volume of the cavity and the orifice of the cavity.

In one or more embodiments, the calculation of the acoustic properties at the each frequency of the range of frequencies includes at least one of an acoustic wave amplitude attenuation of the each frequency, a pressure at the each frequency, an acoustic velocity at the each frequency, or a temperature at the each frequency.

### EXAMPLE 2

A software architecture encoded on a non-transitory computer-readable medium the software architecture including a first protocol, wherein the first function is configured to model acoustic properties at an orifice of a cavity using inverse integration, wherein the first function includes a first protocol, wherein the first protocol is configured to transform each linearized navier-stokes wave equation into a frequency domain by taking a Fourier transform. The first function additionally includes a second protocol, wherein the second protocol is configured to discretize volume of the cavity. The first function further includes a third protocol, wherein the third protocol is configured to discretize a set of linearized navier-stokes wave equations based on the volume of the cavity. Moreover, the first function includes a fourth protocol, wherein the fourth protocol is configured to collect the each linearized navier-stokes wave equation into a matrix form, wherein the matrix form includes a boundary value problem. Furthermore, the first function includes a fifth protocol, wherein the fifth protocol is configured to test a range of frequencies at each discretized volume by using the each transformed linearized navier-stokes wave equation, wherein the testing the range of frequencies includes a sixth protocol, wherein the sixth protocol is configured to calculate acoustic properties at each frequency of the range of frequencies.

In one or more embodiments, the fourth protocol includes a seventh protocol, wherein the seventh protocol is configured to specify a reference pressure and a reference amplitude based on an assumed phase distribution of pressure oscillations at the orifice of the cavity.

In one or more embodiments, the first protocol includes an eighth protocol, wherein the eighth protocol is configured to apply known boundary conditions of the cavity to the set of linearized navier-stokes equations; and a ninth protocol, wherein the ninth protocol is configured to extend the set of linearized navier-stokes wave equations at the orifice of the cavity.

In one or more embodiments, the fifth protocol includes a tenth protocol, wherein the tenth protocol is configured to evaluate impedance of acoustic waves at an entirety of the volume of the cavity and the orifice of the cavity.

In one or more embodiments, the calculation of the acoustic properties at the each frequency of the range of frequencies includes at least one of an acoustic wave amplitude attenuation of the each frequency, a pressure at the each frequency, an acoustic velocity at the each frequency, or a temperature at the each frequency.

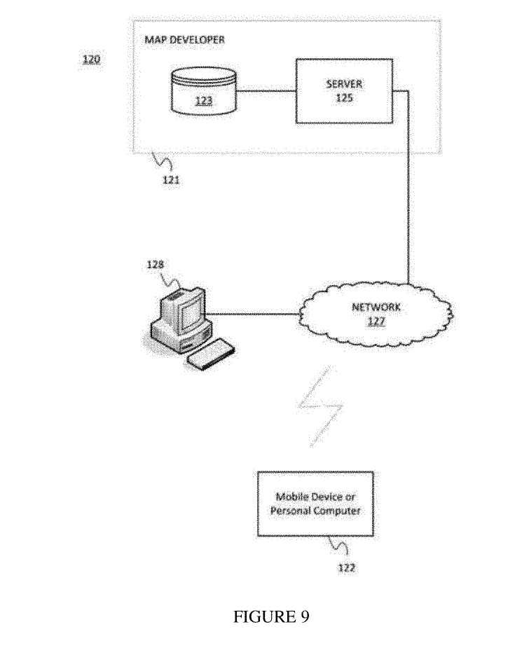

The above method may be performed by a mobile device, personal computer, or workstation and controller and/or server and processor. FIG. 9 illustrates one embodiment of an acoustic modeling system 120. The system 120 may include a map developer system 121, a mobile device or personal computer 122, a workstation 128, and a network 127. Additional, different, or fewer components may be provided.

The mobile device or personal computer 122 may be a smart phone, a mobile phone, a personal digital assistant (“PDA”), a tablet computer, a notebook computer, a desktop computer, a personal navigation device (“PND”), a portable navigation device, and/or any other known or later developed mobile device or personal computer.

The developer system 121 includes a server 125 and a database 123. The developer system 121 may include computer systems and networks of a system operator such as HERE, NAVTEQ, or Nokia Corporation. The database 123 is configured to store various data, as well as reconstructed data processed by the server and algorithm. The server 125 is configured to receive various data.

The developer system 121, the workstation 128, and the mobile device or personal computer 122 are coupled with the network 127. The phrase “coupled with” is defined to mean directly connected to or indirectly connected through one or more intermediate components. Such intermediate components may include hardware and/or software-based components.

The workstation 128 may be a general purpose computer including programming specialized for providing input to the server 125. For example, the workstation 128 may provide settings for the server 125. The settings may include a value for the predetermined interval that the server 125 requests mobile device 122 to relay current geographic locations. The workstation 128 may be used to enter data indicative of GPS accuracy to the database 123. The workstation 128 may include at least a memory, a processor, and a communication interface.

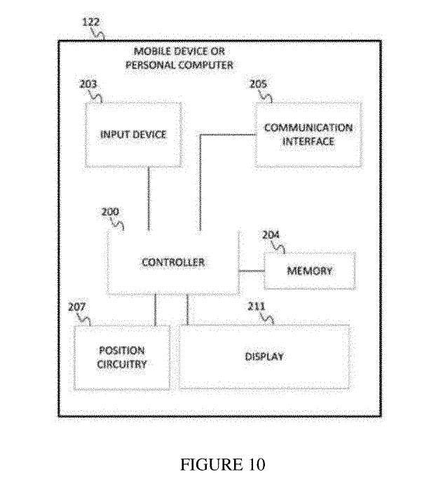

FIG. 10 illustrates an exemplary mobile device or personal computer 122 of the system of FIG. 9. The mobile device or personal computer 122 includes a controller 200, a memory 204, an input device 203, a communication interface 205, position circuitry 207, and a display 211. Additional, different, or fewer components are possible for the mobile device/personal computer 122.

The controller 200 may be configured to receive data indicative of the location of the mobile device or personal computer 122 from the position circuitry 207. The positioning circuitry 207, which is an example of a positioning system, is configured to determine a geographic position of the mobile device or personal computer 122. The positioning system may also include a receiver and correlation chip to obtain a GPS signal. The positioning circuitry may include an identifier of a model of the positioning circuitry 207. The controller 200 may access the identifier and query a database or a website to retrieve the accuracy of the positioning circuitry 207 based on the identifier. The positioning circuitry 207 may include a memory or setting indicative of the accuracy of the positioning circuitry.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, design, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

1. A non-transitory computer-readable medium encoded with a computer-readable program which, when executed by a processor, will cause a computer to execute a computational method, the computational method comprising:
modeling acoustic properties at an orifice of a cavity using inverse integration, wherein the modeling comprises:
transforming each linearized navier-stokes wave equation into a frequency domain by taking a Fourier transform;
discretizing volume of the cavity;
discretizing a set of linearized navier-stokes wave equations based on the volume of the cavity;
collecting the each linearized navier-stokes wave equation into a matrix form, wherein the matrix form comprises a boundary value problem; and
testing a range of frequencies at each discretized volume by using the each transformed linearized navier-stokes wave equation, wherein the testing the range of frequencies comprises calculating acoustic properties at each frequency of the range of frequencies.

2. The method of claim 1, wherein the collecting the each linearized navier-stokes wave equation into the matrix form comprises:
specifying a reference pressure and a reference amplitude based on an assumed phase distribution of pressure oscillations at the orifice of the cavity.

3. The method of claim 1, wherein the transforming the each linearized navier-stokes wave equations based on the cavity comprises:
applying known boundary conditions to the cavity to the set of linearized navier-stokes equations; and
extending the set of linearized navier-stokes wave equations at the orifice of the cavity.

4. The method of claim 1, wherein the testing the range of frequencies of the each discretized volume by using the each transformed linearized navier-stokes wave equation comprises:
evaluating impedance of acoustic waves within an entirety of the volume of the cavity and the orifice of the cavity.

5. The method of claim 1, wherein the calculation of the acoustic properties at the each frequency of the range of frequencies comprises at least one of an acoustic wave amplitude attenuation of the each frequency, a pressure at the each frequency, an acoustic velocity at the each frequency, or a temperature at the each frequency.

6. A non-transitory computer-readable medium encoded with a computer-readable program which, when executed by a processor, will cause a computer to execute a computational method, the computational method comprising:
modeling acoustic properties at an orifice of a cavity using inverse integration, wherein the modeling comprises:
transforming each linearized navier-stokes wave equation into a frequency domain by taking a Fourier transform;
discretizing volume of the cavity;
discretizing a set of linearized navier-stokes wave equations based on the volume of the cavity;
collecting the each linearized navier-stokes wave equation into a matrix form, wherein the matrix form comprises a boundary value problem;
specifying a reference pressure and a reference amplitude based on an assumed phase distribution of pressure oscillations at the orifice of the cavity; and
testing a range of frequencies at each discretized volume by using the each transformed linearized navier-stokes wave equation, wherein the testing the range of frequencies comprises calculating acoustic properties at each frequency of the range of frequencies.

7. The method of claim 6, wherein the transforming the each linearized navier-stokes wave equations based on the cavity comprises:
applying known boundary conditions to the cavity to the set of linearized navier-stokes equations; and
extending the set of linearized navier-stokes wave equations at the orifice of the cavity.

8. The method of claim 6, wherein the testing the range of frequencies of the each discretized volume by using the each transformed linearized navier-stokes wave equation comprises:
evaluating impedance of acoustic waves within an entirety of the volume of the cavity and the orifice of the cavity.

9. The method of claim 6, wherein the calculation of the acoustic properties at the each frequency of the range of frequencies comprises at least one of an acoustic wave amplitude attenuation of the each frequency, a pressure at the each frequency, an acoustic velocity at the each frequency, or a temperature at the each frequency.

10. A non-transitory computer-readable medium encoded with a computer-readable program which, when executed by a processor, will cause a computer to execute a computational method, the computational method comprising:
transforming each linearized navier-stokes wave equation into a frequency domain by taking a Fourier transform;
discretizing volume of the cavity;
discretizing a set of linearized navier-stokes wave equations based on the volume of the cavity;
collecting the each linearized navier-stokes wave equation into a matrix form, wherein the matrix form comprises a boundary value problem; and
testing a range of frequencies at each discretized volume by using the each transformed linearized navier-stokes wave equation, wherein the testing the range of frequencies comprises calculating acoustic properties at each frequency of the range of frequencies.

11. The method of claim 10, wherein the collecting the each linearized navier-stokes wave equation into the matrix form comprises:
specifying a reference pressure and a reference amplitude based on an assumed phase distribution of pressure oscillations at the orifice of the cavity.

12. The method of claim 10, wherein the transforming the each linearized navier-stokes wave equations based on the cavity comprises:
applying known boundary conditions to the cavity to the set of linearized navier-stokes equations; and
extending the set of linearized navier-stokes wave equations at the orifice of the cavity.

13. The method of claim 10, wherein the testing the range of frequencies of the each discretized volume by using the each transformed linearized navier-stokes wave equation comprises:
evaluating impedance of acoustic waves within an entirety of the volume of the cavity and the orifice of the cavity.

14. The method of claim 10, wherein the calculation of the acoustic properties at the each frequency of the range of frequencies comprises at least one of an acoustic wave amplitude attenuation of the each frequency, a pressure at the each frequency, an acoustic velocity at the each frequency, or a temperature at the each frequency.

15. The method of claim 3, the known boundary conditions are applied to cavity boundaries of the cavity, but not the orifice.

16. The method of claim 7, the known boundary conditions are applied to cavity boundaries of the cavity, but not the orifice.

17. The method of claim 12, the known boundary conditions are applied to cavity boundaries of the cavity, but not the orifice.

18. The method of claim 1, wherein the cavity comprises at least one of any shape, any volume, or any topology.

19. The method of claim 6, wherein the cavity comprises at least one of any shape, any volume, or any topology.

20. The method of claim 10, wherein the cavity comprises at least one of any shape, any volume, or any topology.
